(19) United States
(12) Patent Application Publication
(10) Pub. No.: US 2025/0382826 A1
(43) Pub. Date: Dec. 18, 2025

(54) LOCKSET WITH DUAL MESSAGE INDICATORS

(71) Applicant: Townsteel Inc., City of Industry, CA (US)

(72) Inventors: Sybor Ma, La Puente, CA (US); Yuanjin Kuo, New Taipei City (TW); Jinchun Liu, Shanghai (CN); Chad P. Moon, Colorado Springs, CO (US)

(21) Appl. No.: 19/239,002

(22) Filed: Jun. 16, 2025

Related U.S. Application Data
(60) Provisional application No. 63/660,496, filed on Jun. 15, 2024.

(51) Int. Cl. E05B 41/00; E05B 1/00; E05B 9/00; E05B 9/04

(52) U.S. Cl. CPC E05B 41/00; E05B 1/003; E05B 9/002; E05B 9/04; E05B 2009/046

(57) ABSTRACT

A lockset for an accessway has coordinated inside and outside indicators to display the lock status. The lockset may also include a faculty lock function to enhance privacy. The lockset may also include a protective failure point in the outside handle to prevent damage from forced entry attempts. A dual action retract linkage may be included to allow the inside handle to both unblock and retract the bolt for convenient egress.

### RELATED APPLICATIONS

This application claims the benefit of U.S. Provisional Patent App. No. 63/660,496, filed Jun. 15, 2024, entitled “Lockset with Dual Message Indicators,” which is herein incorporated by reference in its entirety for all intents and purposes.

### FIELD OF THE INVENTION

The present disclosure relates generally to locksets for access-controlled areas. In particular, the disclosure relates to locksets with coordinated inside and outside indicators, protective failure points in a handle, and/or a faculty lock function.

### BACKGROUND

Locksets are essential for securing doors and controlling access to various spaces. Traditional locksets typically have separate mechanical visual indicators on the inside and outside of the door to show whether the door is locked or unlocked. However, these indicators may not always be reliable, may not function in unison, and it can be difficult to determine the status of the lock from the outside without attempting to open the door.

Furthermore, traditional locksets can be vulnerable to forced entry attempts. When excessive force is applied to the outside handle, the internal components of the lock can be damaged, rendering it inoperable. This can create a security risk and may require costly repairs or replacement of the lockset.

Additionally, it would be beneficial to have specialized locksets that offer enhanced privacy features, such as in faculty restrooms. Such locksets should allow authorized individuals to enter the space while preventing unauthorized access, even if the individual possesses a key.

Furthermore, it would be beneficial to have locksets with multi-use components that allow the lockset to be configured for different functions.

### SUMMARY

The background section describes several features that are desirable. The invention, however, include any one of or combination of these features. The invention may also include other features as will become apparent from reading the specification, drawings, and/or claims.

The present invention provides various locksets with improved features for enhanced security, convenience, and/or privacy. The lockset includes coordinated inside and outside indicators mounted within the inside and outside trim, respectively, that reliably display the lock status to both sides of the door. These indicators move in unison via a mechanical linkage, providing clear visual feedback to insiders and outsiders regarding whether the accessway is locked, unlocked, occupied, or vacant.

In another embodiment, the lockset includes an inside access control and an outside access control, each operable independently to transition between blocking and nonblocking states. A first blocker prevents rotation of the outside handle unless the inside access control is in a nonblocking state, while a second blocker prevents rotation of the outside handle unless the outside access control is in a nonblocking state. The outside handle is operable to rotate only when both blockers are in nonblocking positions, while the inside handle is always operable to retract the bolt and allow egress.

In yet another embodiment, the lockset includes a protective failure point or region in the outside handle, designed to fail when torque exceeding a predetermined threshold is applied. This failure mechanism prevents damage to internal components, such as the latch actuator, and frustrates forced entry attempts. The failure point may be implemented using weld spots, shear pins, or dowels, as described in the specification.

The lockset may further include a dual action retract linkage that allows the inside handle to simultaneously transition the inside access control from a blocking state to a nonblocking state and retract the bolt for convenient egress. The linkage interacts with a slider-crank mechanism, which includes a pivoting seat and slider assembly, to enable this dual functionality.

A still further embodiment of the lockset provides a faculty lock function that allows authorized individuals to enter a space while preventing unauthorized access, even if the individual possesses a key. In this embodiment, the inside access control (e.g., a thumbturn) and the outside access control (e.g., a key cylinder) operate independently, with the inside access control capable of overriding the outside access control to prevent entry. The lockset may also include an access recovery mechanism, such as a screwdriver-actuated recovery control, to transition the inside access control to a nonblocking state in emergency situations.

A related embodiment of the lockset provides a storeroom function that allows outsiders to enter the storeroom using a key or other security credential, while allowing insiders to exit freely, regardless of the state of any blocker or locking mechanism. Unlike the faculty lock function, the storeroom function does not allow the insider to permanently block access via the outside access control. However, temporary blocking may be achieved by holding the inside access control (e.g., thumbturn) in a blocking position with sufficient force to frustrate attempts to transition it to a nonblocking state.

Another embodiment provides one or more access recovery mechanisms, including concealed apertures in the outside trim that allow maintenance personnel to operate a recovery actuator using a screwdriver or similar tool. These mechanisms may be used to transition the inside access control to a nonblocking state or retract the bolt entirely, even if the outside handle has been broken off during a forced entry attempt.

The lockset described herein is applicable to a wide range of industries, including residential, commercial, institutional, and industrial settings. It is particularly suited for applications requiring enhanced security, privacy, and convenience, such as classrooms, faculty restrooms, storerooms, private offices, and secure areas.

### BRIEF DESCRIPTION OF THE DRAWINGS

The drawings presented with this application illustrate several different embodiments or models of a new lockset. The displayed models share certain common features or functions. The models also differ from each other in other, selectable features and functions. Not all common or selectable features and functions shown are necessary, as modifications could be made without obviating the novelty of the models illustrated herein.

FIG. 2 illustrates inside and outside faces of one embodiment of a lockset which is locked that includes a thumbturn, a key cylinder, inside and outside handles, and a bolt.

FIG. 3 illustrates the lockset of FIG. 2 when the thumbturn is in an unblocked state.

FIG. 4 illustrates a side view of the lockset of FIG. 1.

FIG. 5 illustrates components of the lockset of FIG. 1 that are housed in the outside trim while both the inside and outside access controls and first and second blockers are in blocking states.

FIG. 6 illustrates components of the lockset of FIG. 1 with backplate pieces removed, revealing operational components housed in the outer trim (e.g., spindles, cams, blockers and tailpieces) and operated by inside and outside access controls, wherein the first blocker is in a nonblocking state.

FIG. 7 is a perspective view of the lockset of FIG. 5.

FIG. 8 is a perspective view of the lockset of FIG. 6.

FIG. 9 is a perspective view of one embodiment of a stop plate that rotates with the outside handle and provides a slot for a blocker to block the stop plate and outside handle from rotating.

FIG. 10 is a partially exploded perspective view of some of the internal components of the outside trim or escutcheon of a first embodiment of the lockset.

FIG. 11 is a perspective view of the outside trim of FIG. 10 with the internal components illustrated in FIG. 10 mounted to the outside trim and with the first blocker in the blocking position.

FIG. 12 is a perspective view of one embodiment of a crank in the outside trim for driving a slider with a blocker between nonblocking and blocking positions.

FIG. 13 is a rear perspective view of the crank of FIG. 10, showing a receptacle of one embodiment of an access recovery control.

FIG. 14 is a perspective view of one embodiment of a blocker in the outside trim that is driven by a slider which itself is driven by the crank of FIG. 11.

FIG. 15 is an exploded perspective view from the outside of the trim back of many of the internal components of the outside trim or escutcheon of a second embodiment of the lockset, wherein the first blocker is in the nonblocking position.

FIG. 16 is an exploded perspective view like that of FIG. 15, but with the first blocker in the blocking position.

FIG. 17 is a partially exploded perspective view of the lockset of FIG. 16.

FIG. 18 is an exploded perspective view of components of the inside trim of one embodiment of the lockset.

FIG. 19 is a partially exploded perspective view of additional components of the inside trim of one embodiment of the lockset.

FIG. 20 is a plan view of one embodiment of the inside trim of one embodiment of the lockset, showing a corresponding first blocker in an upward position.

FIG. 21 is another plan view of the inside trim of FIG. 20, showing the corresponding first blocker in what would be a blocking position but for the fact that the stop plate is inverted.

FIG. 22 is a perspective view of the inside trim of FIG. 20, showing a corresponding first blocker in an upward position.

FIG. 23 is a perspective view of the inside trim of FIG. 21, showing the corresponding first blocker in what would be a blocking position but for the fact that the stop plate is inverted.

FIG. 24 is a perspective view of another layer of components of the inside trim of FIG. 20, where the inside handle is cranked downwardly, and a crank mounted to the inside handle spindle is in a bolt retracting position.

FIG. 25 is a plan view of the inside trim depicted in FIG. 24.

FIG. 26 is a plan view of the outside trim from the outside with the outside access control (as shown, a key cylinder) in a nonblocking (horizontal keyhole) position and the indicator displaying “Vacant.”

FIG. 27 is a plan view of the outside trim, again from the outside, with the outside access control (key cylinder) in a neutral blocking (vertical keyhole) position and the indicator displaying “Occupied.”

FIG. 28 is a perspective view of FIG. 27.

FIG. 29 is a side view of FIG. 27.

FIG. 30 is a plan view of one embodiment of the outside trim, from the inside, revealing the tailpiece of the outside access control (e.g., key cylinder) and the first blocker in the blocking position.

FIG. 31 is a plan view of FIG. 30, revealing the tailpiece in a partially rotated position, a cam on a spindle coaxial with the inside access control's spindle also partially rotated, and the first blocker in the nonblocking position and lightly held there by detents that the movement of the inside or outside access control can overcome.

FIG. 32 is a plan view of the outside trim at a deeper layer revealing the second blocker, showing the first blocker in the nonblocking position and lightly held there by detents that the movement of the inside and/or outside access control can overcome.

FIG. 33 is a plan view of the outside trim revealing the second blocker, which is a blocking plate that travels up and down in response to key-actuated movement of an oblong cam, and which in this figure is in a blocking position.

FIG. 34 is a partially exploded view of the outside trim of one embodiment of the lockset in a nonblocking state.

FIG. 35 is a perspective view of one layer of components of the outside trim of FIG. 34, after its components have been assembled for installation.

FIG. 36 is a partially exploded perspective view of many of the components of the outside trim of one embodiment of a faculty privacy lockset (name is arbitrary).

FIG. 37 is a perspective view of the faculty privacy lock of FIG. 36, with the previously separated components assembled inside the outside trim.

FIG. 38 is a partially exploded perspective view of many of the components of the inside trim of one embodiment of the lockset, showing the stop plate in an inverted position that disables the components from locking the inside handle.

FIG. 39 is a perspective view of the lockset of FIG. 38, with the previously separated components assembled inside the inside trim.

FIG. 40 is a plan view of the outside trim of an embodiment of the lockset having an outside handle with a frangible or breakable failure point at or near the base of the handle, thereby frustrating an overtorquing attack and protecting internal components of the lockset.

FIG. 41 is a plan view of the outside trim of FIG. 40 after an overtorquing attack has caused the outside handle to fall off, revealing a second access recovery control.

FIG. 42 is a bottom plan view of the outside handle, including a clamping portion used to secure the handle to the lockset.

FIG. 43 is top plan view of the outside handle.

FIG. 44 is a side plan view of the outside handle.

FIG. 45 is a perspective view of the outside handle, showing also a shear joint in the form of a sleeve and actuator to which the handle attaches.

FIG. 46 is an exploded view of the sleeve and actuator of FIG. 45, revealing computer-calibrated point welds and/or weld regions on the sleeve that connect the sleeve to the outside handle.

FIG. 47 is a perspective view of another embodiment of a shear joint in the form of weld points and/or regions between the sleeve and the actuator.

FIG. 48 is an exploded view of FIG. 47, revealing computer-calibrated point welds and/or weld regions between the sleeve and the actuator that are designed to fail when the torque applied to the handle exceeds a threshold.

FIG. 49 is an exploded perspective view of another embodiment of a shear joint of FIG. 48 utilizing a frangible dowel pin that extends through the sleeve and the actuator as well as a screwdriver bit receptacle of the shear joint.

FIG. 50 illustrates FIG. 49 with the sleeve and actuator joined together and in relation to the outside handle.

FIG. 51 is an exploded perspective view of another embodiment of a shear joint that employes a shear key, shear pin, or dowel that is inserted into a pair of grooves-parallel to the axis of the shear joint—in the sleeve and actuator of the shear joint.

FIG. 52 is a perspective view of the shear joint of FIG. 51, showing the sleeve and actuator joined by the dowel pin.

FIG. 53 is an exploded view of another embodiment of a shear joint, like that of FIG. 51 except that a square bit receptacle has been replaced with a star bit receptacle.

FIG. 54 is a perspective view of FIG. 53, which provides a better view of the actuator groove.

FIG. 55 is a perspective view of the outside slider crank mechanism-maintaining a blocking position or state-inside the outside trim.

FIG. 56 is a perspective view of the outside slider crank mechanism maintaining a nonblocking position or state.

FIG. 57 is an exploded perspective view of the inside slider crank mechanism which enables the inside handle crank to drive the inside lock spindle to a nonblocking state and allows the inside handle to return to a neutral, horizontal position without pulling the inside lock spindle into a blocking state.

FIG. 58 is a plan view of the inside slider crank mechanism operated into a nonblocking position or state.

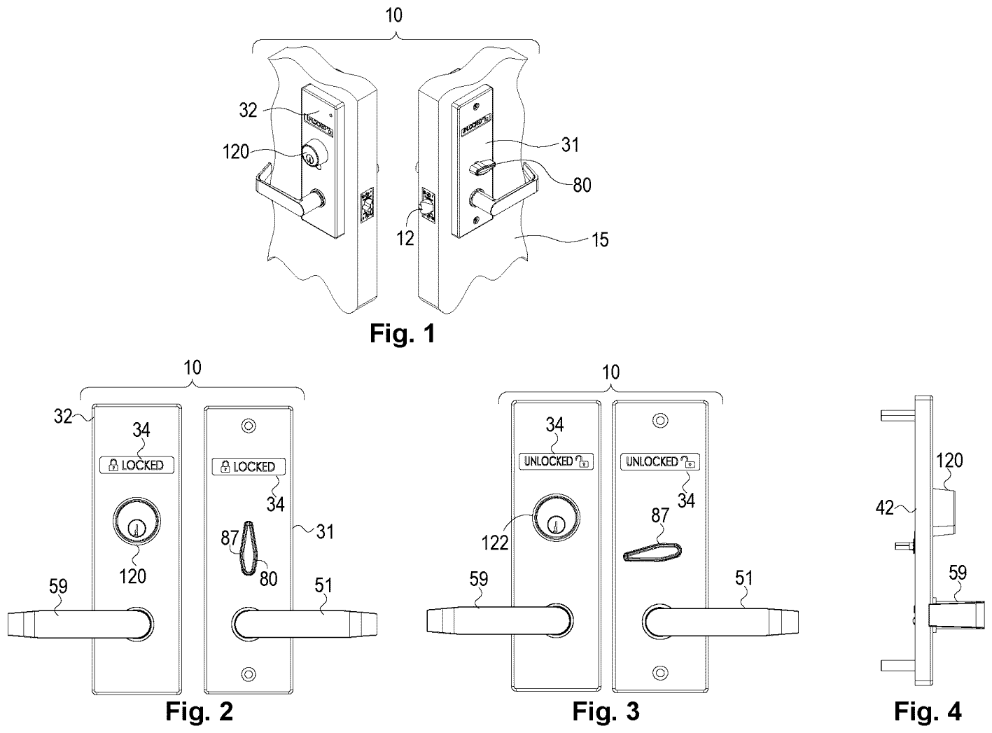

### DETAILED DESCRIPTION

The detailed description and drawings are provided to illustrate the invention and should not be construed as limiting the scope of the claims. Features described in one embodiment may be combined with features from other embodiments to create additional configurations. The claims define the scope of the invention, and the specification should be interpreted to support the broadest reasonable interpretation of the claims.

This specification describes several different embodiments or models of a new lockset design. The displayed models share certain common features or functions. The models also differ from each other in other, selectable features and functions. Not all the common or selectable features and functions described are necessary, as modifications could be made without obviating the novelty of the models or of various combinations of their base components illustrated herein. Also, while the depicted embodiments are for tubular locksets, many aspects of the design could be applied to mortise and cylindrical locksets.

Most of the models include dual status indicators, one displayed to the inside and the other displayed to the outside, revealing whether the lockset is locked or unlocked or the protected access area is closed or open, occupied or vacant, or otherwise inaccessible or accessible. The term “indicator” refers to any visual or symbolic display that communicates the status of the lockset, such as “locked,” “unlocked,” “occupied,” or “vacant.”

The status indicators are linked together to move in unison, even though the inside and outside handles are, at least under certain conditions, independently operable, as are the inside and outside access controls.

A dual status indicator has especial value in a lockset for a classroom. It immediately lets both teachers and students in the classroom, and security personnel on the outside, know whether the classroom door is locked or not, without having to test the lockset itself. It is also valuable for other applications as well, such as privacy, so an insider doesn't need to look closely at or physically test the lockset to know whether their door is locked.

A standard model provides a thumbturn or other inside access control accessible by a human on the inside (an “insider”) and a key cylinder or other outside access control accessible by a human on the outside (an “outsider”). The inside and outside indicators are mounted for uniform movement to the sliders of the slider-cranks of the inside and outside trim, respectively, or to the blockers that are coupled to the sliders. Optionally, the standard model includes a second blocker to prevent outside handle rotation. The second blocker is driven between blocking and nonblocking states by the outside access control. The second blocker may be a blocking plate coupled by an outside lock spindle cam to the outside access control that selectively lifts and lets down the blocking plate.

A more basic model does not provide a typical outside access control such as a key cylinder, but it does provide an access recovery control so that a maintenance or otherwise properly equipped person can restore the thumbturn or other inside access control to an unlocked state.

An enhanced model, which has especial value as a faculty privacy lock, features an inside access control (e.g., thumbturn), an outside access control (e.g., key cylinder), and an access recovery control to return the thumbturn to an unlocked state.

An enhanced security feature, which may be applied to any of the above models, features a shearable outside handle and a second access recovery control to operate the bolt even after the outside handle has sheared or broken off.

All these models may be modified in various ways without departing from the spirit of the invention. For example, the lockset may be adapted for a storeroom function with no inside access control or a confinement function that permits ingress but blocks egress unless a credential is provided. In the latter adaptation, the inside and outside trim may be switched to the opposite sides of the door or gate. As another example, electronically operated elements such as a keypad, card reader, biometric reader, or contactless credential reader replace one or more hand-operated access control or access recovery elements.

### Lockset Overview

As with nearly every physical lock, the lockset 10 is installed to an accessway, such as a door frame or alternatively a door, and controls access or limits entry to an access-controlled area. In very special applications, such as in a prison or psychiatric ward, the lockset 10 controls exit from a guarded, restraining, or other exit-restricted access-controlled area. Those on the inside and outside of the accessway may be described as “insiders” and “outsiders,” respectively.

Basic parts that are universal to most embodiments of lockset 10 comprise a main bolt 12. As used herein, the term “bolt” refers to any locking mechanism, including latchbolts, lockbolts, or hybrids thereof, that secures an accessway. The drawings do not depict separate latch and lockbolts, but many different and familiar modifications could be made to include one of each. The main bolt 12 secures the door in the closed position and prevents unauthorized entry when engaged. The lockset 10 includes inside and outside handles 51 and 59, respectively, such as the levers depicted in the drawings. The inside handle 51 is always-except in confinement models of the lockset 10—to retract the main bolt 12. The outside handle 59 is operable to retract the main bolt 12 only when the lockset is unlocked. The lockset 10 also includes a human-accessible inside access control 80, such as a thumbturn 87, that operates the main bolt 12. The lockset 10 also features inside and outside trim 31 and 32—which double as housing 41 and 42 for the lock's components-providing a finished appearance.

A significant, though not necessary, feature is the provision of coordinated status indicators 34 in both the inside and outside trims 31 and 32. Through windows or apertures 33 present in both trims, the status indicators 34 visually display to both insiders and outsiders whether entry is permitted or disallowed, or if the access-controlled area is locked, unlocked, open, closed, vacant, occupied, accessible, or inaccessible. The precise wording or symbology is not important, and other words and symbols may be used to indicate the same or equivalent statuses. The indicators 34 are attached to and/or etched in or formed with inside and outside indicator plates 35 and 37 that move within the trims, optionally guided by guides or guide plates 39, to visually display whether the lockset 10 is in a locked or unlocked state.

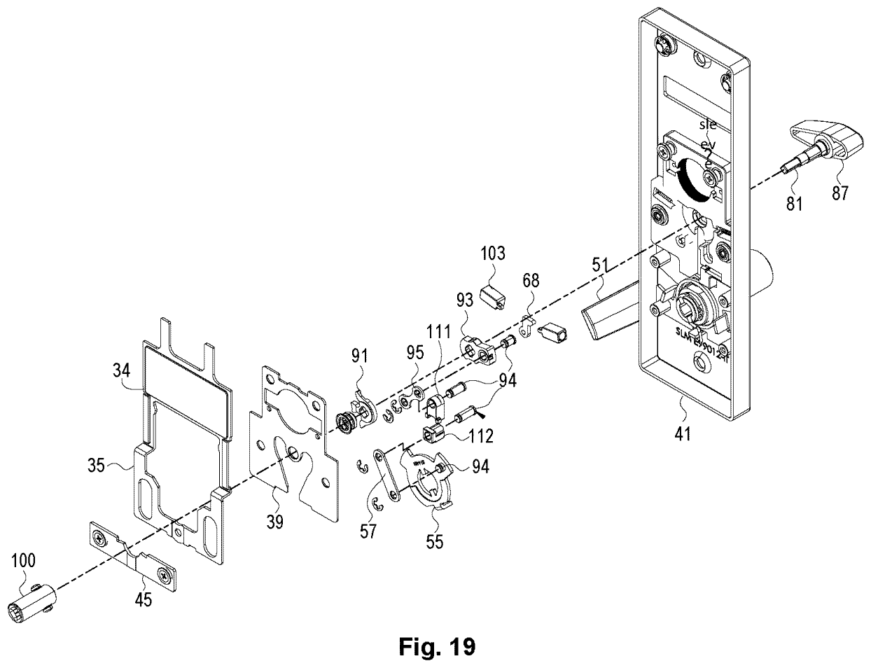

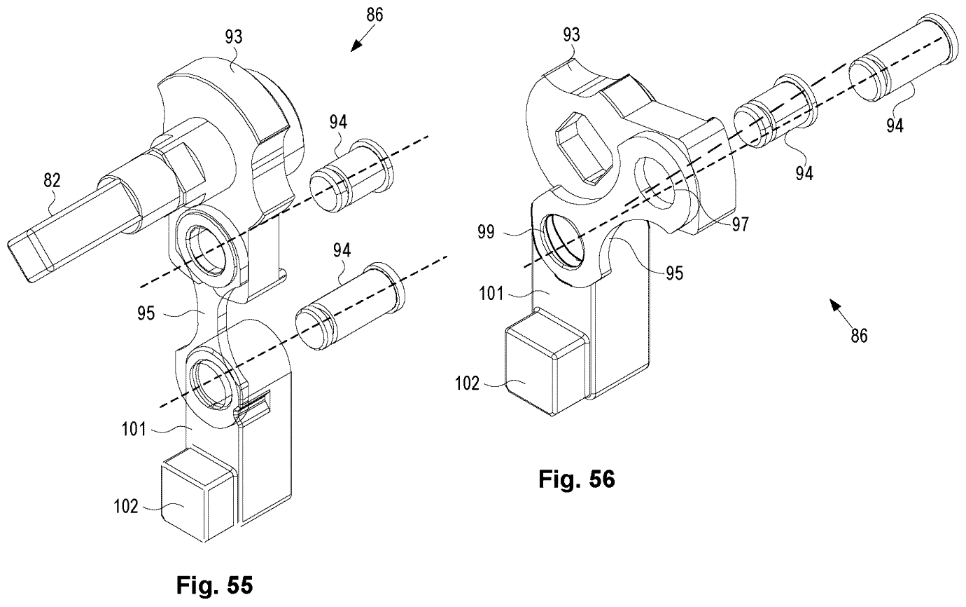

As explained in greater detail below, the inside and outside status indicators 34 are physically linked together, so that action on one side of the door is operative to change the indications simultaneously. This is so even though in most embodiments the components and functions on either side are not symmetrical. For example, actions on the inside are operative to move a thumbturn 87 and inside handle 51 and retract the main bolt 12 without moving the outside handle 59 or affecting a key cylinder. The status indicators 34 are connected to inside and outside slider-crank mechanisms 110 and 86, each of which comprises a crank 93, a rod or equivalently functioning link 95 or 57, and a slider 101 or 111 (FIGS. 55-58). The crank 93 extends radially between an inside or outside lock spindle 81 (FIG. 19) or 82 (FIG. 10) and a revolute joint 97 (e.g., pivot pin 94) connecting the crank 93 to one end of the connecting rod or linkage 95. The other end of the rod or link 95 is connected via—and also pivots with respect to—a linearly restricted sliding joint 99 (FIGS. 14, 56) of the slider 101. The status indicators 34 are mounted to the slider 101 or the joint 99. The mounts are pivot pins 94 to avoid jamming the indicator plates 35 and 37 as they ascend or descend inside the trims 31 and 32.

### Handles and Related Components

As mentioned above, the inside handle 51 operates the main bolt 12, retracting it to allow the door to open whether or not one of the locking/blocking mechanisms is engaged. An inside spindle extension or driver 55, such as a disc, cam or crank, projects radially from the inside handle 51 (or an inside handle spindle, not shown) and interacts with the inside access control 80. A linkage 57—i.e., a single link, as shown, or a system or arrangement of multiple links-connects the inside handle 51 to the inside access control 80, allowing the insider access control 80 to be operated upon exiting the access-controlled area.

On the outside, an outside handle 59 is used to attempt entry. It is connected to an outside handle-driven actuator 175. A stop plate 63 rides on the outside handle spindle and interacts with blockers to prevent or allow rotation of the outside handle. The stop plate 63 includes a first slot or blocker interface 65 that receives a first stopper 102 (FIGS. 14 & 56) and a second blocker interface 67 that receives the second locking blocker 131. The term “blocker” refers to any component that prevents rotation of a handle or operation of an access control.

As an interjectory matter, it should be noted that in the displayed embodiments, several components of the inside and outside trims 31, 32—including, for example, various spindles, cams and other extensions from the spindles, and stop plates 63 and 64—are identical. However, not all these symmetrical components are necessarily mounted, interconnected and functional in the same way. In the interest of brevity, many (although not all) of these identical components are referred to by the same reference number. Differences-specific to the inside and outside trims 31 and 32—between the components and/or their functions will be evident from the drawings as elucidated by this description.

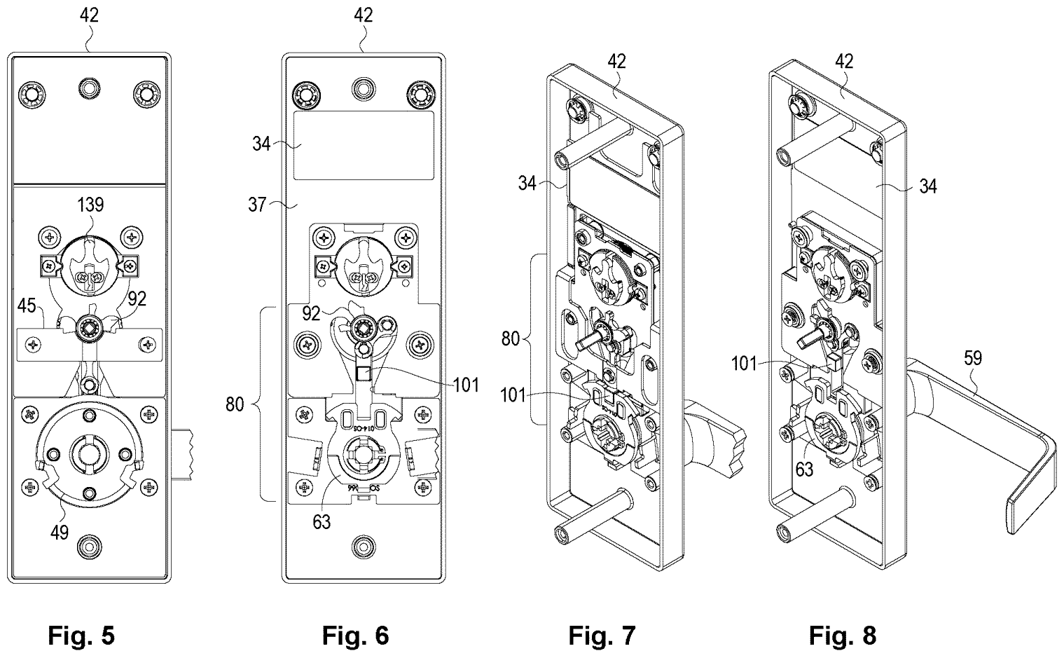

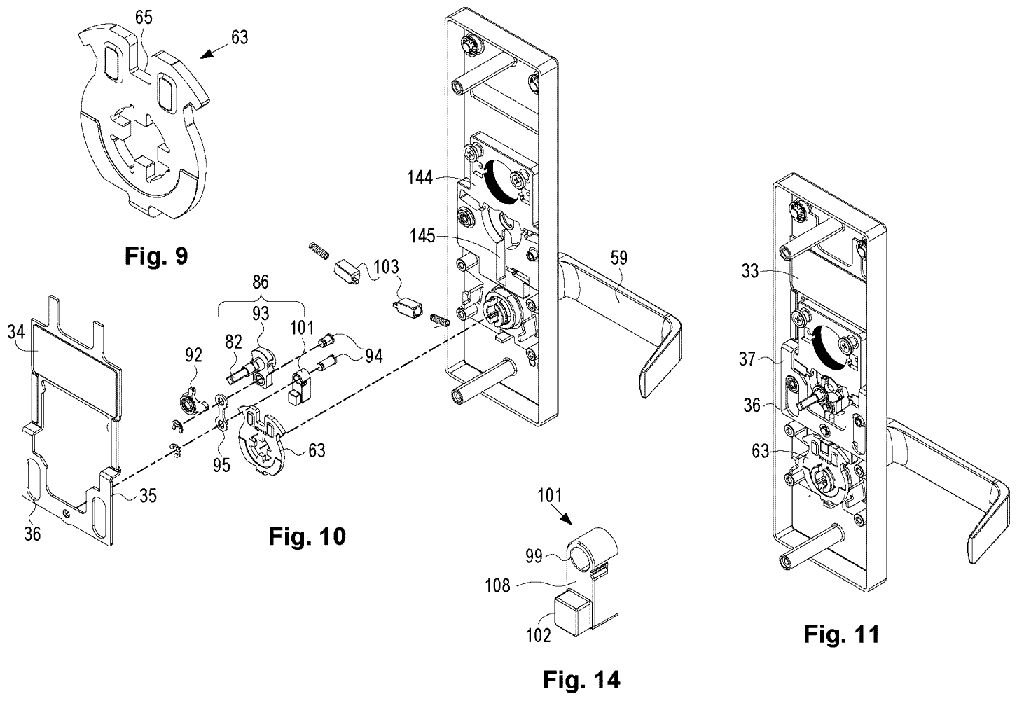

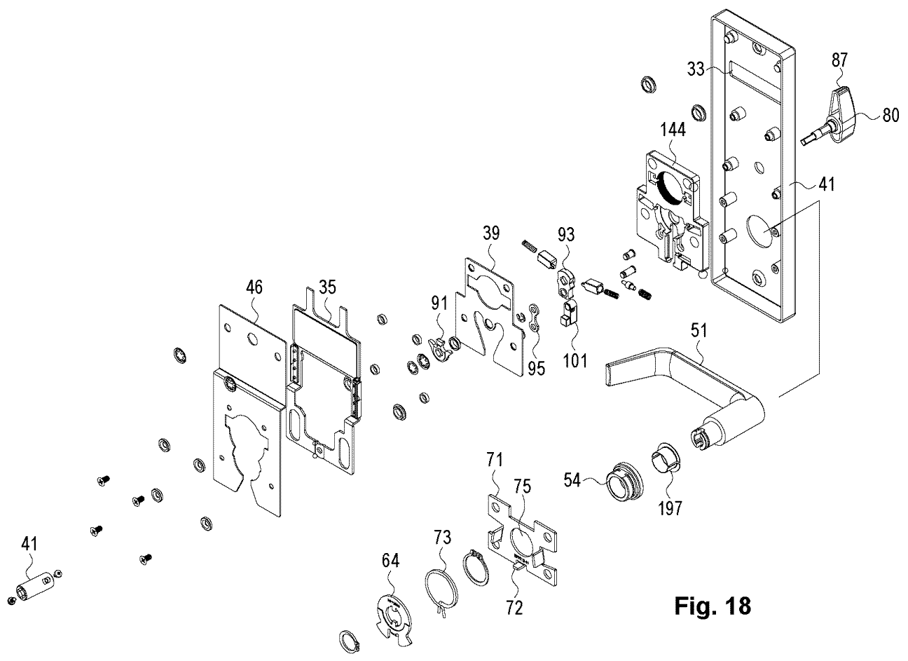

The various figures also enumerate several minor components that can be briefly addressed for completeness. Various housing or retaining components include a bracket 45 (FIG. 5), a cover plate 49 (FIG. 5)), a reinforcement plate 66 (FIG. 15), a backplate or key-cylinder mounting plate 144 (FIG. 18), a blocker slide or guide 145 in the backplate (FIG. 15), a retaining plate 46 (FIG. 18), a handle return spring 73 (FIG. 18), a bushing/trim piece 54 for the lever (FIG. 18), and a bearing plate or torsion spring bracket 71 (FIG. 18). A spring leg stop 72 extends from the bearing plate or bracket 71 to hold spring legs of the torsion spring 73 in tension. The torsion spring 73 biases the outside handle 59 to the neutral or default (horizontal) position. The outside handle 59 mounts in opening 75 in the bearing plate or bracket 71 (FIG. 18).

### Inside Access Control 80

The inside access control 80—which is operated by an inside lock lever 87, for example, a thumbturn—is responsible for operating the reciprocating blocking slider 101. It is referred to herein as an “inside” access control because direct human operation of the access control is from the inside. In some embodiments, an outside access control 120 and/or a first access recovery control 160—for example, a key cylinder 121 and/or a screwdriver lock, respectively—may also operate the inside access control 80. Moreover, the “inside” access control 80 comprises some components that are located in the outside trim 32. The specific mechanism for extending and retracting the main bolt 12 can vary, as ordinarily skilled artisans are familiar with various designs.

The inside lock lever 87 is connected to an inside lock spindle 81—illustrated in the drawings, but not limited to, a square spindle-which, when rotated, drives various components within the lockset 10. A connecting sleeve 100 inserted through a corresponding hole of or drilled into the accessway (e.g., door) has a spindle-mating passage through it for connecting the inside lock spindle 81 to an outside lock spindle 82, which rotate in unison with each other.

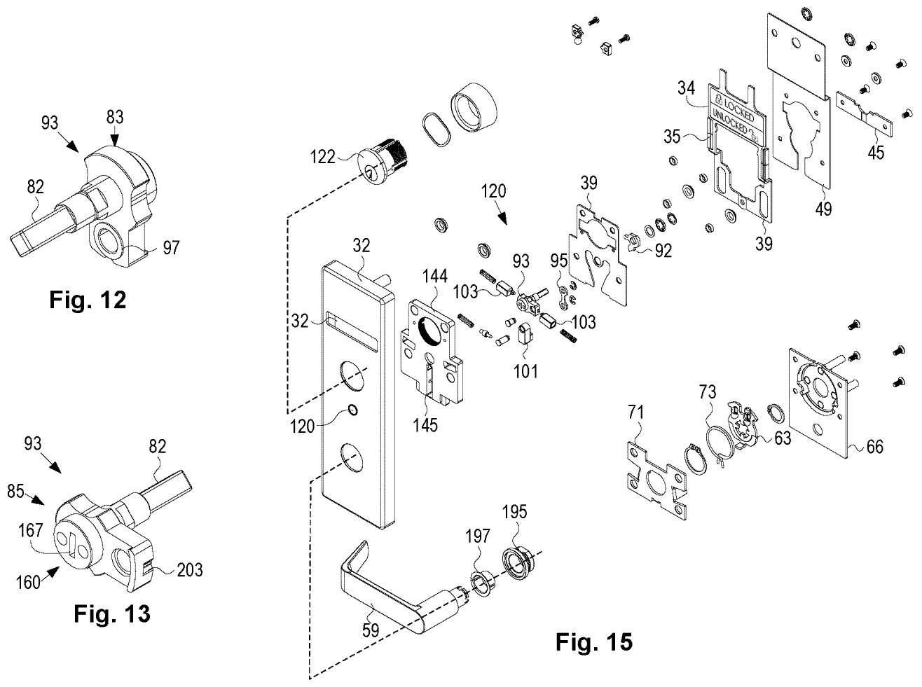

The inside access control 80 is responsible for selectively blocking rotation of the outside handle 59. The control 80 has a blocking state 83, where entry from the outside is prevented, and a non-blocking state 85, where entry is allowed if not otherwise blocked. The blocking and non-blocking states 83 and 85 (FIGS. 12 & 13, respectively) may be alternatively characterized as locking and unlocking states. In the illustrated models, the outside handle 59 is not free to retract the main bolt 12 via the outside handle 59 unless both the inside and outside access controls 80 and 120, respectively, are in unblocking states. Contrariwise, the inside handle 51 is preferably operable to both unblock the access control(s) 80 and/or 120 and retract the main bolt 12.

Blocking by the inside access control 80 is actuated through the previously mentioned slider-crank mechanism 86. Stated generally, the slider 101 selectively moves a stopper 102 in or out of a mating slot or stopper interface 65 of a stop plate 63 mounted for coincident movement with the outside handle 59. On the other hand, the slider-crank mechanism 110 inside the inside trim 31 does not, at least with respect to the illustrated embodiments, effect blocking of the inside handle 51. Furthermore, even when blocking slider 101 or second locking blocker 131 stop the outside handle 59 from rotating, the inside handle 51 is still free to rotate and retract the main bolt 12. This is evident in the drawings by the optional but usual inversion of the inside stop plate 64, so even the assembly of the reciprocating blocking slider 101 in the inside trim 31 is ineffective to block the inside handle 51 from rotating. While most implementations of the lockset 10 do not require access control in both directions, the component assembly is flexible enough to support such a configuration—by, for example, uprighting the inside stop plate 64 (FIG. 18) in the inside trim 31, replacing the split slider 111, 112 with slider 101, and replacing the thumbturn with another key cylinder.

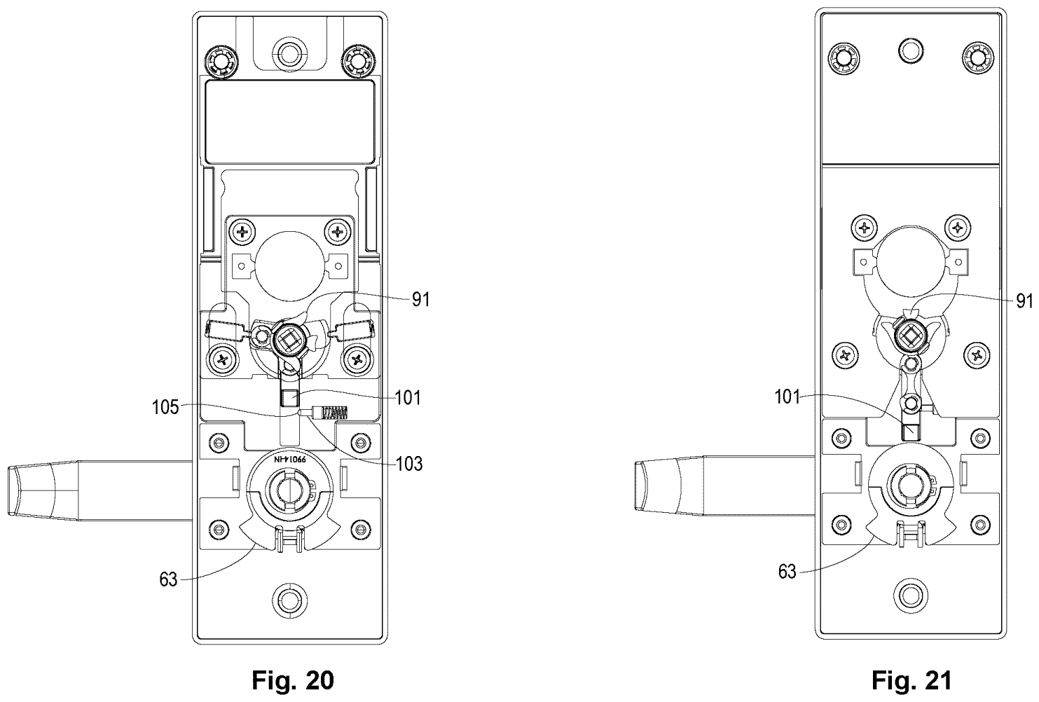

Stated more particularly, a crank or driver 93 projects radially from the outside lock spindle 82 and, through a rod or first linkage 95, drives a reciprocating blocking slider 101 (inside the outside trim 32) between blocking and non-blocking positions or states 83 and 85 (FIGS. 12 & 13). The reciprocating blocking slider 101 comprises a slider 108 (FIG. 14), a stopper 102 such as a block, tab or other protuberance at one end of the slider, and the previously mentioned revolute rod-slider joint 99 at the other end of the slider 108. Both joints 97 and 99 comprise connecting pins 94, on which the rod or linkage 95 pivots. Spring-biased detents 103 engage corresponding grooves 105 (FIG. 20) in the crank 93 to bias the crank or driver 93 in either a locking or unlocking position. The combination of the crank or driver 93 with the connecting rod or linkage 95 converts rotational motion of the lock spindle 82 into linear movement of the stopper 102.

Incidentally, both the inside and outside slider-crank mechanisms are operated by the inside access control 80—solely, in some embodiments; or additionally, in other embodiments, by the outside access control 120 and/or access recovery control 160. Both the inside and outside slider-crank mechanisms 110 and 86 provide an important communication function—moving the inside and outside indicators 34 in unison to indicate the lock status.

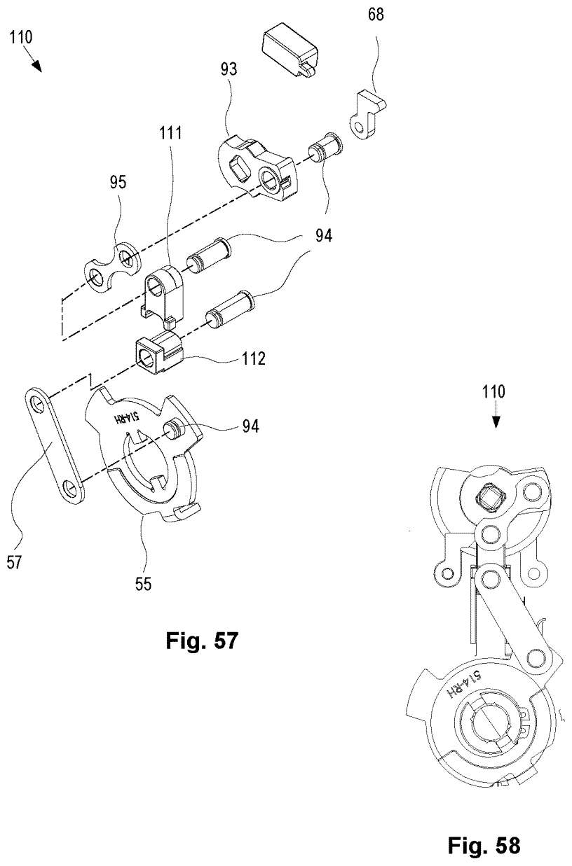

In some embodiments (e.g., FIG. 19), the inside slider-crank mechanism 110 (FIG. 57) is slightly modified from the outside slider-crank mechanism 86. The inside slider-crank mechanism is not actually used to block anything, so the slider is not properly referred to as a “blocking slider.” Instead of a slider 101 that blocks rotation of the inside handle, a nonblocking slider 111 is configured to interconnect with a seat 112 pivotally mounted to the linkage 57 of the inside handle crank 55. The nonblocking slider 111 and pivoting seat 112 can push but not pull each other. Accordingly, the inside handle 51, when pushed downwardly, operates to push the nonblocking slider 111 upwardly to return the inside lock lever 87 to a nonblocking position 85 and retract the main bolt 12. Because the nonblocking slider 111 and pivoting seat 112 can be disconnected from each other, the inside handle torsion spring returns the inside handle 51 to the neutral position even if the inside lock lever 87 and crank 93 remain in a nonblocking position or state.

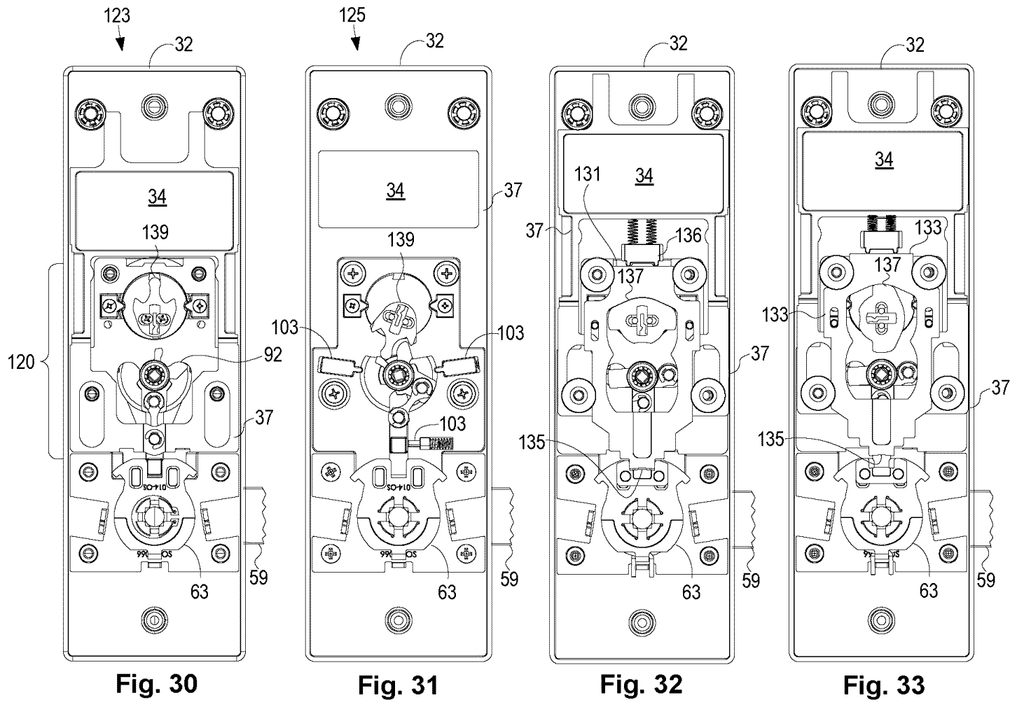

For standard privacy lock functions, the outside housing 42 may contain a key-operated tailpiece 139. To interact with the tailpiece 139, the inside access control 80 may include a cam 91 and/or 92 on the inside and/or outside lock spindle 81 and/or 82 (FIGS. 30-31). In some embodiments, the cam 91 or 92 interacts with a tailpiece 139 of the inside key cylinder. This allows the inside access control 80 to operate the key cylinder as well as the reciprocating blocking slider 101, and vice versa. Cams 91 and 92 may be configured for different lockset functions. Both cams may be included in a lockset assembly in order to give the installer a choice of different lockset configurations.

Alternatively, for example for a faculty privacy lock function, the outside housing 42 may contain a key-operated cam 137 instead of a tailpiece 139 (FIGS. 32-33). In the faculty privacy lockset, cams 91 and 92 do not have any function. The outside access control has no tailpiece and there is no interaction between the inside access control and the outside access control.

### Outside Access Control

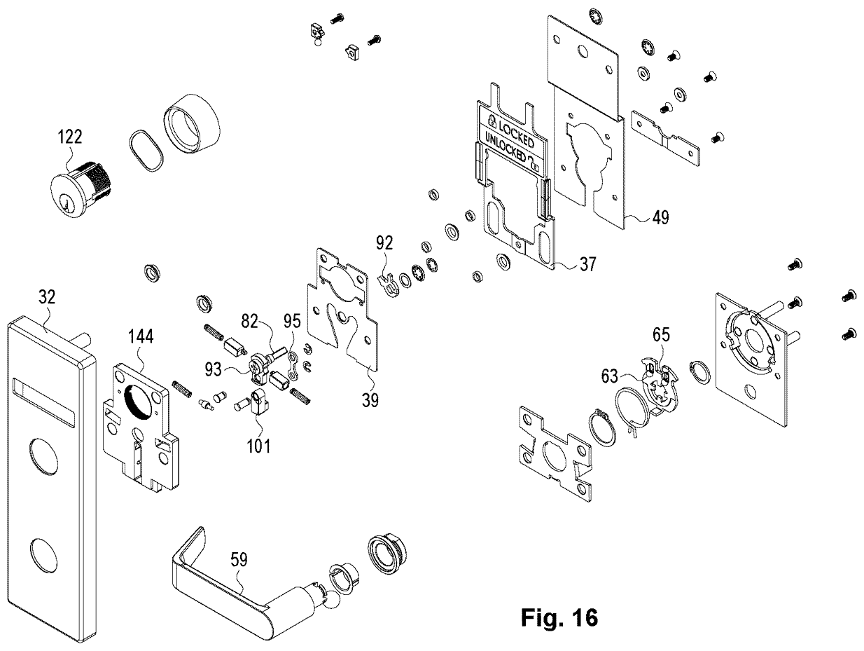

The outside access control 120 is typically a key cylinder 122 (FIG. 16), but it can also be other manual or electronic lock mechanisms, such as a keypad, biometric sensor, card reader, or token sensor. Like the inside access control 80, it has a blocking state 123 and a non-blocking state 125 (FIGS. 30-31).

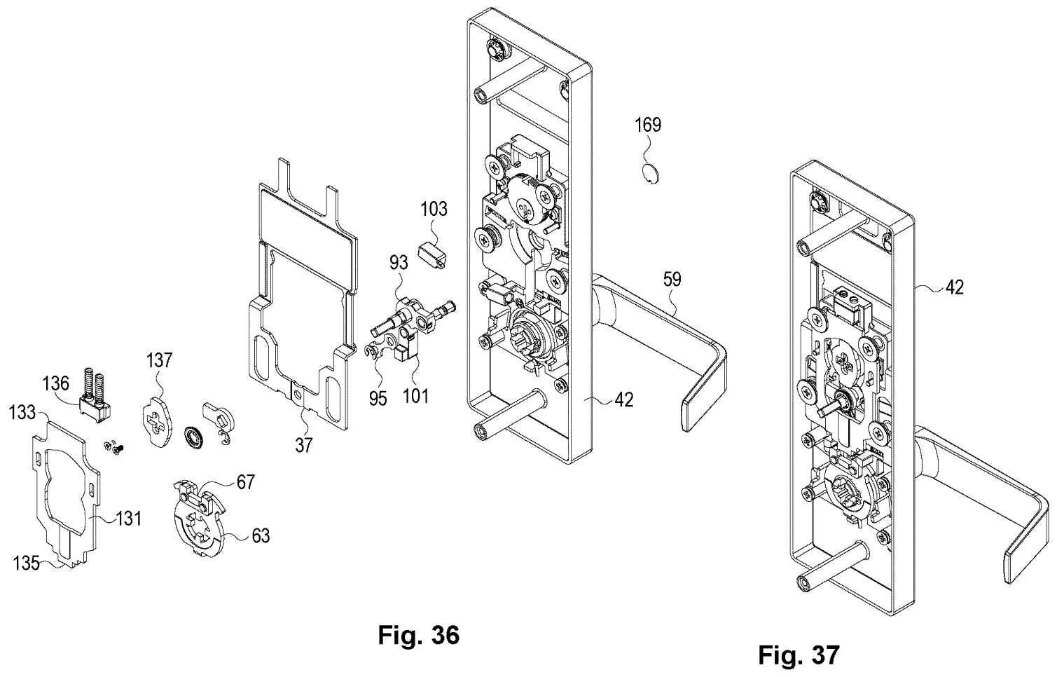

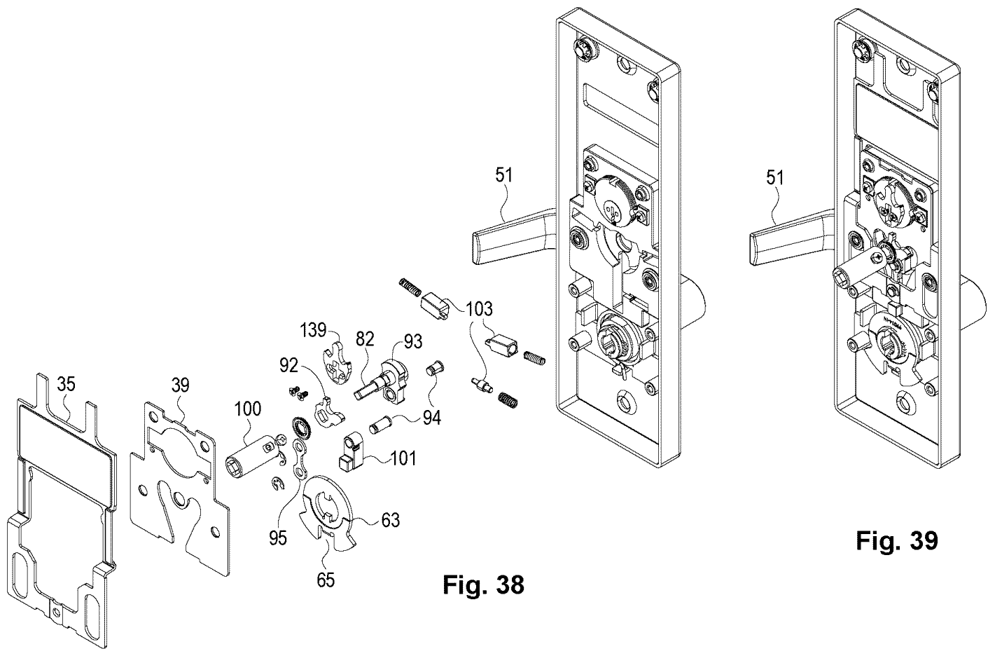

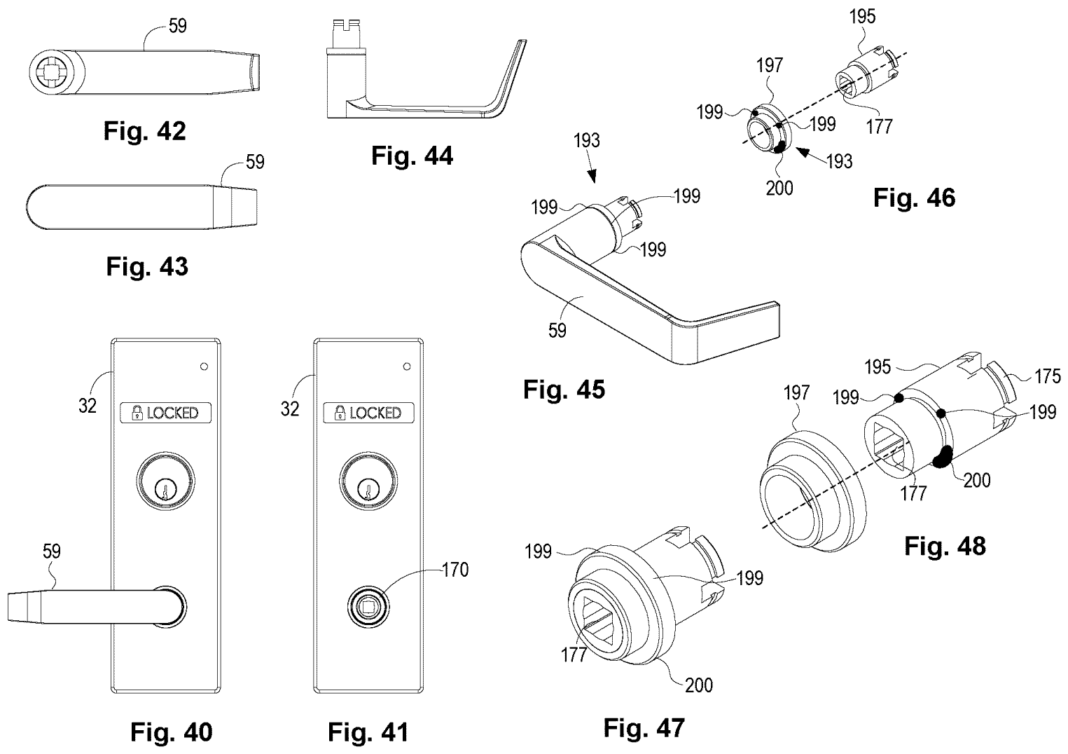

The outside access control operates a second lock spindle 129, which in some embodiments drives the tailpiece 139 which in turn drives a cam 91 or 92 on the inside access control. In other embodiments, such as in the faculty privacy lockset, the second lock spindle 129 drives a second locking blocker 131 (FIG. 36). This blocker 131 includes a blocking plate 133 and a blocking section 135 that mates with a second blocker interface 67 on the stop plate 63 (FIG. 36). A cam 137 on the second lock spindle 129 controls the movement of the second locking blocker 131 between blocking and non-blocking positions.

A second driver or tailpiece 139 is mounted on the second lock spindle. In many embodiments, this driver can drive the cam on the inside access control, potentially allowing the outside access control to override the inside access control under certain conditions.

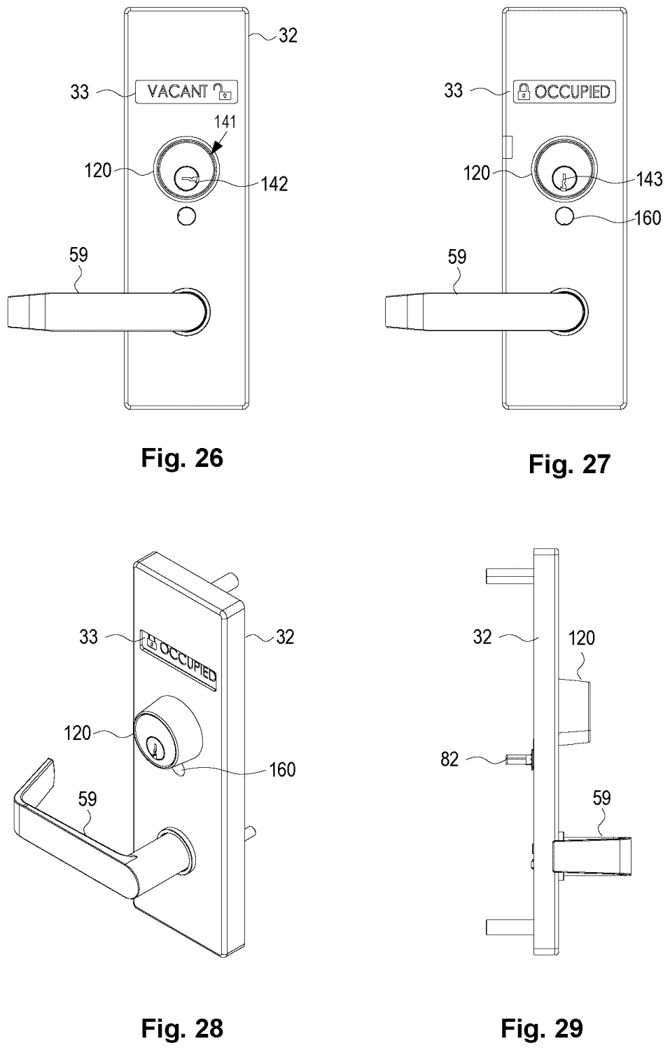

If the outside access control 120 is a key cylinder 122, it may have a key cylinder slot 141 (FIG. 26) with a neutral or default position or state 143 (FIG. 27) that biases the cam 137 into a blocking position, preventing entry from the outside. Inserting and turning an appropriate key can transition the outside access control 120 into a non-blocking position or state 142.

### Access Recovery Controls

The lockset 10 may include one or more concealed outside access recovery controls 160, 170. The first access recovery control 160 is coaxial with the outside lock spindle 82 of the inside access control 80. It operates the inside access control 80 through a first concealed receptacle 167 (FIG. 13) on the outside-facing side of the crank or driver 93.

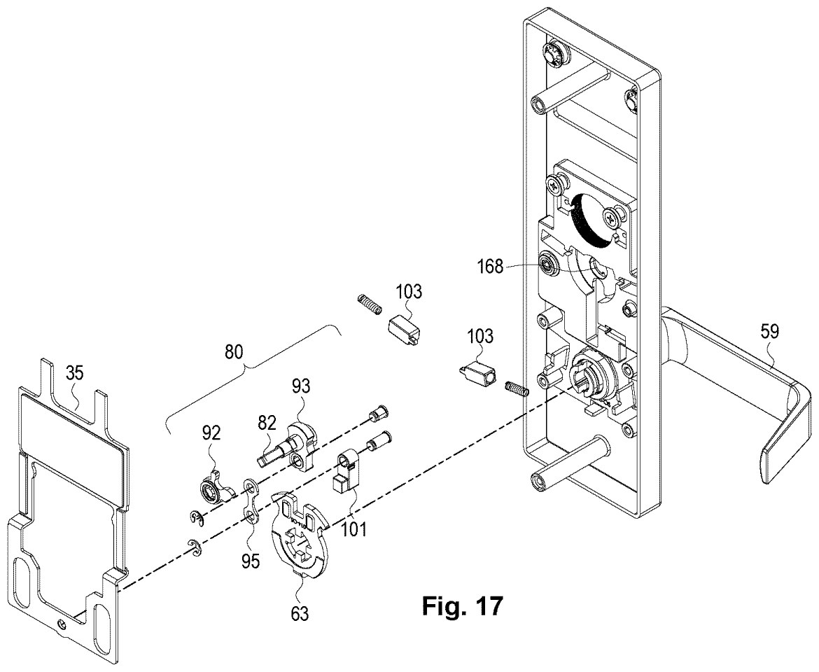

The first concealed receptacle 167 is accessed through an aperture 168 (FIG. 17)—normally concealed by cover 169 (FIG. 36)—using a first screwdriver bit that mates with the first concealed receptacle 167. In the displayed embodiment, the receptacle 167 is formed in the crank 93 of the inside access control 120.

An outside lock spindle 82—illustrated in the drawings, but not limited to, a square spindle—when rotated, drives the inside lock spindle 81. A connecting sleeve 100 between the inside and outside lock spindles 81 and 82 makes this possible.

The second access recovery control 170, illustrated in FIGS. 42-55, is coaxial with the outside handle spindle 59. It includes a second receptacle 177 formed in an outside handle-driven actuator, adapter, or linkage 175 that transfers force from the outside handle 59 to components used to retract the main bolt 12. The specific mechanism for extending and retracting the main bolt 12 can vary, as ordinarily skilled artisans are familiar with various designs.

With both the first and second recovery controls 160 and 170, the screwdriver bit may a standard, nonstandard, or security bit, such as a flat driver, Philips driver, square driver, star bit driver, hex driver, or even a spanner driver or socket or other equivalent that is inserted through the outside trim into the receptacle. FIGS. 42-49 illustrate a receptacle/socket for a square bit. FIGS. 50-51 illustrate a receptacle for a star bit.

### Faculty Privacy Lock

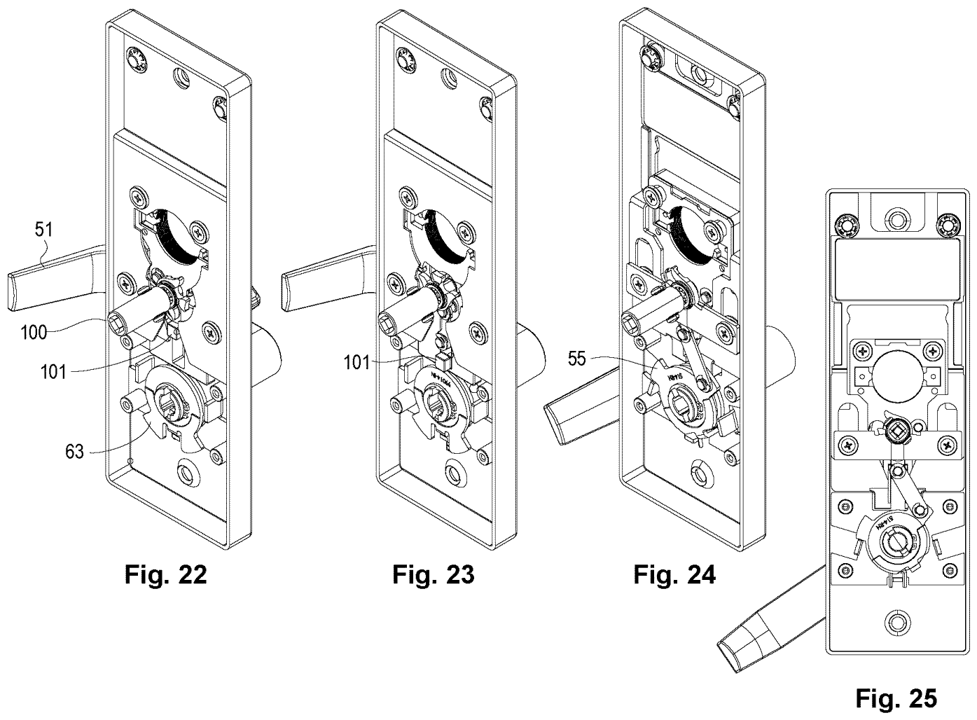

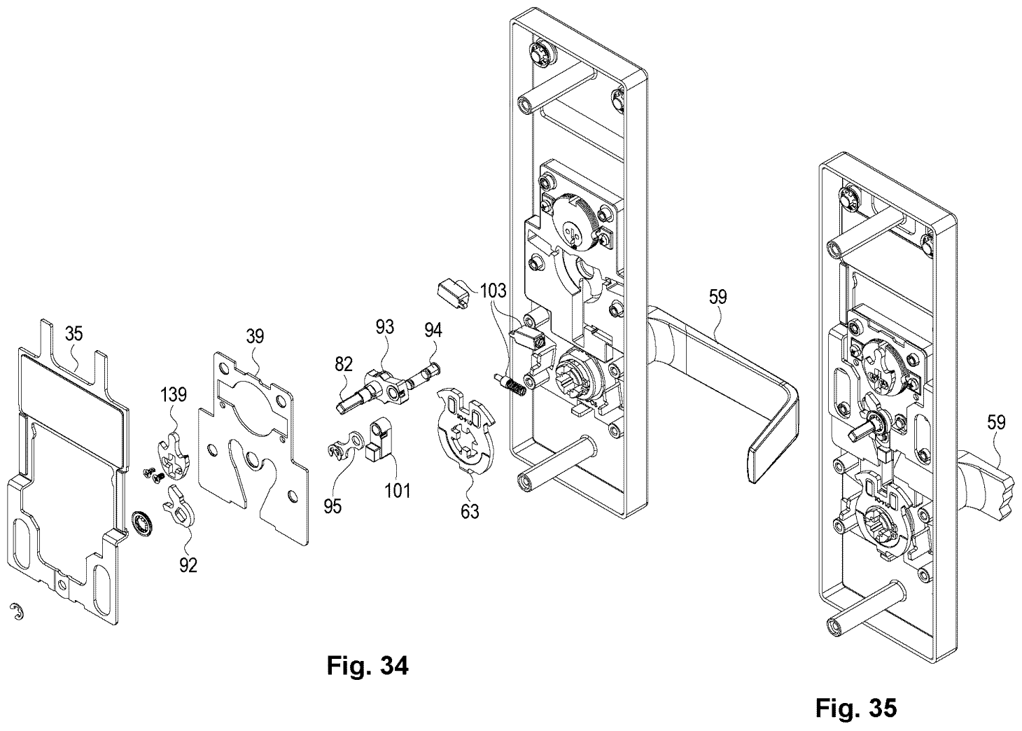

FIGS. 22-35 illustrate various embodiments of what may be referred to as a faculty privacy lockset, although the mechanism has applications outside of the faculty context including private offices and secure areas. Many institutions of higher learning provide faculty-exclusive restrooms separate from the main restrooms available to students and the public. For such and other applications, faculty or otherwise privileged members may be given keys or access credentials to operate locksets for the faculty-exclusive restrooms, whose use is required to enter the restroom. Persons inside the restroom (“insiders”) can turn a thumbturn or operate some other inside access control to prevent outside faculty members (“outsiders”)—even those with the aforementioned keys or access credentials—from entering. At the same time, the lockset provides an indication to outsiders, and the same or a related indication to insiders, that the lockset is locked, the space is occupied, something else to that effect, or vice versa.

An outsider who attempts to unlock the lockset using their key or other access credential will find that the door remains locked. This is because while the key or other outside access control may be effective to unblock a first blocking mechanism preventing rotation and operation of the outside handle, it is not effective to unblock a second blocking mechanism that is controlled from the inside. In order to unlock the lockset and gain entry into the private or otherwise protected area, the outsider is expected to wait until the insider transitions the inside access control to an unblocking state. In an emergency situation—for example, when the access-controlled space has been locked for hours and no one inside responds to commands or queries—the first access recovery control (described above) may be utilized by an appropriately equipped or credentialed maintenance person—to retract the main bolt 12 and force the inside access control back into an unblocking state. Then, the lockset may be operated by a key or other outside access control to also transition the outside access control into an unblocking state. When both inside and outside access control are in an unblocking state, the outside handle may be operated to retract the main bolt 12.

FIGS. 22-25 illustrate the outside trim 32 of a faculty privacy lockset. Each of the locksets features an outside handle 59, outside key cylinder 120, first concealed access recovery control 160 and indicator window 33. An outside indicator 34 reveals some lock status message or optionally colored lock symbol (such as closed or open, locked or unlocked, entry permitted or denied, occupied or vacant, a locked padlock symbol on a red background or an unlocked padlock symbol on a green background) that the inside area is vacant and open or accessible to those with the proper key or credentials.

FIGS. 30-31 provide rear views of the outside trim 32 where a cam 92 interacts with a tailpiece 139. FIG. 30, in particular, reveals the outside indicator plate 37 in a descended position, the stopper 102 received in the stop plate slot 65, and the lock cylinder or other outside access control tailpiece 139 in an upwardly projecting position corresponding with the neutral and default locking state of the key cylinder. The cam 92 is operable through rotation to drive an upwardly projecting tailpiece 139 of the lock cylinder or other outside access control 120 toward a downwardly projected position.

FIGS. 32 and 33 reveal the lockset 10 in blocked and unblocked states, respectively. In this embodiment, the lockset 10 has an oblong cam 137 instead of a tailpiece 139. In FIG. 32, the cam 137 is in a horizontal position, the lockset 10 is in a doubly blocked and locked state as both the inside and outside access controls 80 and 120 are oriented into blocking states 83/123. In FIG. 33, the cam 137 is in a vertical position, lifting the second locking blocker 131 (which may comprise a blocking plate 133) out of engagement with the stop plate 63. When the oblong cam 137—which is mounted for uniform rotation with a key cylinder 128 or other rotating lock mechanism—is rotated back into a horizontal position, the force of the spring-biased pressure bar 136 forces the blocking plate 133 in a descended, blocking position.

### Protective Failure Point Mechanism

To protect against forced entry attempts, the lockset 10 may include a protective failure point mechanism 191. This mechanism has a failure point or region 193 designed to break under a specific torque threshold, preventing damage to the lock's internal components.

The failure point or region 193 may be implemented in various ways, such as weld spots or weld sections 199 that are designed to fail under excessive torque, or shear keys, shear pins, or dowels 201 that shear off when a predetermined force is applied.

In FIGS. 45-46, a failure point or region 193 is created with point welds 199 or weld sections 200 between the outside handle 59 and a shear sleeve 197 already fixated to an outside-handle latch actuator 195. When the outside handle 59 is sheared or falls off, the shear sleeve 197 and actuator 195 remain and are exposed. In FIGS. 47-48, by contrast, the failure point or region 193 constitutes point welds 199 or weld sections 200 between the sleeve 197 and the actuator 195. When the outside handle 59 is sheared or falls off, the shear sleeve 197 falls off or is easily removed, exposing the actuator 195.

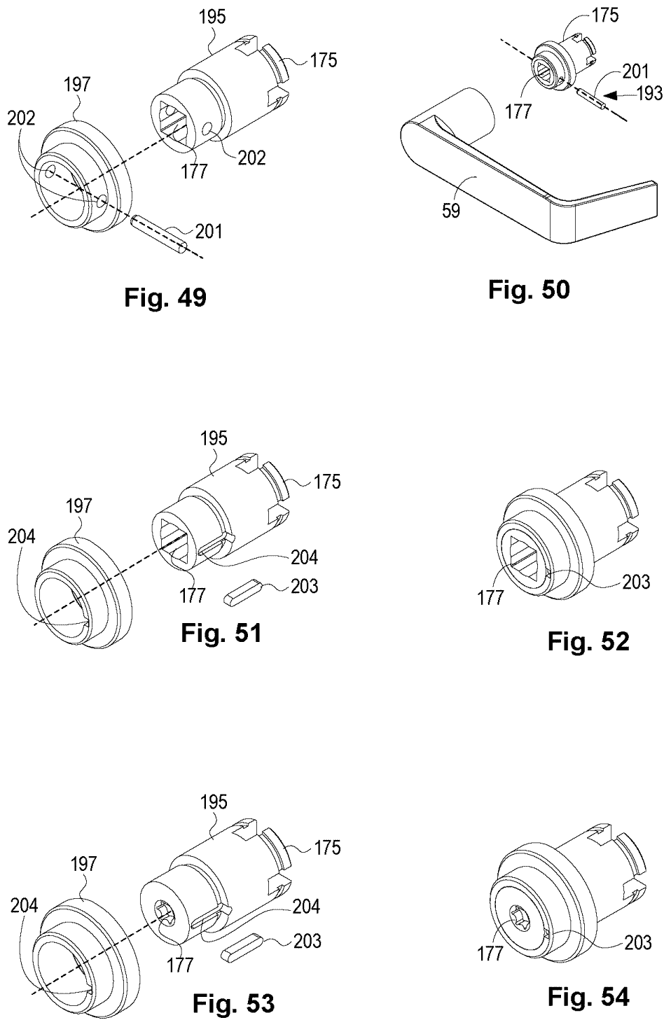

In FIGS. 49-50, the failure point or region 193 is created between the shear sleeve 197 and the actuator 195. As suggested by the holes 202 through the shear sleeve 197 and actuator 195, the failure point or region 193 is a dowel (not shown) that connects the base of the outside handle 59 to the shear sleeve 197 and actuator 195. Alternatively, the dowel extends between only the actuator 195 and sleeve 197, which is fixated to the handle 59. In another alternative, two much shorter dowels 201 extend between only the outside handle 59 and sleeve 197, which is fixated to the actuator 195. The dowel(s) 201, under the application of sufficient torque, break(s), severing the outside handle 59 from the actuator 195 and/or sleeve 197.

In FIGS. 51-54, the failure point or region 193 is implemented as a shear pin or key 203 between the sleeve 197 and the actuator 195. The shear pin or key 203 fits in a pair of grooves 204, one on the male surface of the actuator 195, and the other on a female surface of the sleeve 197. Grooves 204 corresponding to the shear pin or key 203 help connect the sleeve 197 to the actuator 195 before it fails. Under the application of sufficient torque, the shear pin 201 breaks or disengages, causing the shear sleeve 197 to shear off from the actuator 195.

While the embodiments described herein are exemplary, it will be understood that various modifications, adaptations, and alternative configurations may be made without departing from the spirit and scope of the invention. For example, the lockset may be adapted for mortise or cylindrical lock designs, or electronic access controls such as keypads, biometric readers, or contactless credential readers may replace manual access controls. In some embodiments, the lockset may include electronic components such as microprocessors, sensors, or wireless communication modules. These components may enable remote operation, monitoring, or integration with building management systems. Such features are within the scope of the invention. All such embodiments are within the scope of the invention.

Having thus described exemplary embodiments of the present invention, it should be noted that the disclosures contained in the drawings are exemplary only, and that various other alternatives, adaptations, and modifications may be made within the scope of the present invention. Accordingly, the present invention is not limited to the specific embodiments illustrated herein but is limited only by the following claims. Moreover, the claims are intended to cover all equivalents that perform substantially the same function in substantially the same way to achieve substantially the same result. For example, the mechanical linkage described may be replaced with an electronic or hydraulic linkage without departing from the scope of the invention.

We claim:

1. A lockset for an accessway to an access-controlled area, comprising:
an inside trim and an outside trim;
an inside handle and an outside handle mounted to the inside trim and outside trim, respectively;
a bolt configured to control access to the access-controlled area;
an inside access control operable to transition between blocking and nonblocking states;
an outside access control operable to transition between blocking and nonblocking states;
a first blocker operable to prevent rotation of the outside handle unless the inside access control is in a nonblocking state; and
a second blocker operable to prevent rotation of the outside handle unless the outside access control is in a nonblocking state;
coordinated inside and outside indicators mounted within the inside trim and outside trim, respectively, that visually display whether the accessway is locked or unlocked, occupied or vacant, or accessible or inaccessible;
wherein the inside handle is operable to retract the bolt regardless of the blocking state of the inside or outside access controls.

2. The lockset of claim 1, wherein:
the inside and outside indicators move in unison via a mechanical linkage between the inside trim and outside trim; and
the bolt comprises a latchbolt, a lockbolt, or a hybrid thereof.

3. The lockset of claim 1, further comprising:
a protective failure point in the outside handle configured to fail when torque exceeding a predetermined threshold is applied, thereby preventing damage to internal components of the lockset;
wherein the protective failure point comprises one or more weld spots, shear pins, or dowels.

4. The lockset of claim 3, further comprising:
a sleeve coupling the outside handle to a latch actuator;
wherein the protective failure point is located between the sleeve and the latch actuator.

5. The lockset of claim 3, further comprising:
a dual action retract linkage operable to simultaneously transition the inside access control from a blocking state to a nonblocking state and retract the bolt for egress.

6. The lockset of claim 1, wherein the inside access control comprises:
a thumbturn operable by a person inside the access-controlled area;
a first lock spindle connected to the thumbturn;
a first blocker operable to prevent rotation of the outside handle; and
a linkage connecting the first lock spindle to the first blocker.

7. The lockset of claim 6, wherein the outside access control comprises:
a key cylinder operable by a person outside the access-controlled area;
a second lock spindle connected to the key cylinder;
a second blocker operable to prevent rotation of the outside handle; and
a cam connected to the second lock spindle and configured to transition the second blocker between blocking and nonblocking states.

8. The lockset of claim 1, further comprising:
an access recovery mechanism operable to transition the inside access control to a nonblocking state in emergency situations.

9. A lockset for an accessway to an access-controlled area wherein the lockset, when assembled, comprises:
inside trim and outside trim;
indicator windows or apertures through each of the inside trim and outside trim;
inside and outside handles mounted to the inside and outside trim, respectively;
a bolt that controls access to the access-controlled area;
an inside access control having blocking and nonblocking positions and configured for operation by a human in the access-controlled area; and
coordinated inside and outside indicators mounted within the inside and outside trim, respectively, that reveal whether the accessway is locked or unlocked, entry is permitted or disallowed into the access-controlled area, or the access-controlled area is open, closed, vacant, occupied, accessible, or inaccessible.

10. The lockset of claim 9 that, when assembled, further comprises:
a first blocker operable between blocking and nonblocking positions that respectively block and avoid blocking rotation of the outside handle to gain entrance through the accessway;
wherein the outside indicator is mounted on a plate within the outside trim that is coupled to the first blocker to move in unison with the outside indicator.

11. The lockset of claim 9, wherein:
the outside door handle has a failure point or region that, when force exceeds a torque threshold, causes the handle to break; and
the breaking of the outside handle hinders further torque from being applied to a latch actuator of the lockset, protecting the latch actuator from damage.

12. The lockset of claim 11 that, when assembled, further comprises:
an outside handle spindle;
a sleeve coupling the outside handle spindle to a base of the outside handle;
a latch actuator coupled to and operable to rotate with the outside handle spindle;
wherein the failure point or region comprises one or more welds regions between the sleeve and the latch actuator that fail when torque is applied to the outside handle that exceeds a selected threshold.

13. The lockset of claim 11, wherein:
the failure point or region comprises one or more shear keys or shear pins located on a base of the outside handle, a handle coupler, a sleeve, or the latch actuator;
when torque is applied to the outside handle that is approximately 150 Nm or more, the one or more shear keys or shear pins shear off.

14. The lockset of claim 9 that, when assembled, further comprises:
an inside access control vertically offset from the inside handle, wherein the inside access control comprises:
a first lock spindle;
a first extension projecting radially outward from the first lock spindle and configured to rotate with the first lock spindle;
a first blocker movable between blocking and nonblocking positions that respectively block and avoid blocking rotation of the outside handle to gain entrance through the accessway; and
a linkage connecting the first extension to the first blocker;
wherein by moving the first blocker from the nonblocking position to the blocking position, the inside access control transitions from a nonblocking state to a blocking state; and
wherein when the inside access control transitions from the blocking state to the nonblocking state, the blocker moves from the blocking position to the nonblocking position.

15. The lockset of claim 14, wherein:
the first extension turns with the lock spindle between a locking position and an unlocking position; and
the first access control further comprises detents that bias the first extension into maintaining a locking position or an unlocking position.

16. The lockset of claim 14 wherein:
the inside and outside indicators provide visible human-readable messages and/or symbols revealing whether the accessway is blocking or nonblocking or the access-controlled area is open or closed or occupied or unoccupied;
the outside indicator is linked to the blocker so that the first indicator and the blocker move in unison.

17. The lockset of claim 14 that, when assembled, further comprises an outside access recovery control, which comprises:
a concealed aperture through the outside trim;
a recovery actuator adapted to turn an outside lock spindle when operated upon; and
receptacle mounted to the outside lock spindle and accessible via the concealed aperture;
wherein the receptacle is adapted to mate with a screwdriver bit that is inserted through the outside trim into the receptacle;
wherein the inside access control is configured to be transitioned between blocking and nonblocking states by rotation of the screwdriver bit when it is mated with the receptacle.

18. The lockset of claim 14 that, when assembled, further comprises:
an outside access control comprising:
a second lock spindle;
a second blocker that also transitions between blocking and nonblocking states;
a second driver mounted to the second lock spindle that is operable to cam the second blocker between blocking and nonblocking positions;
wherein each of the inside and outside access controls are operable, independently of each other, to block rotation of the outside door handle; and
wherein when both the inside and outside access controls are in nonblocking states, the outside handle is unblocked from rotating.

19. The lockset of claim 18, wherein:
the inside access control further comprises a cam mounted to the first inside lock spindle for rotation with the first inside lock spindle;
the outside access control further comprises a driver that moves in unison with the second lock spindle;
when the inside access control is in the blocking state, operation of the outside access control from the blocking state to the nonblocking state is operable, via force exerted from the driver to the cam of the inside access control, to transition the inside access control into a nonblocking state.

20. The lockset of claim 9 that, when assembled, further comprises:
an extension operative to be rotated by the inside handle spindle; and
a linkage between the extension and the inside access control so that, when a person inside the access-controlled area operates the handle to exit the access-controlled area, the linkage causes the inside access control to transition from the blocking position to the unblocking position.

21. The lockset of claim 9 that, when assembled, further comprises:
a handle crank that moves in unison with the inside handle;
a blocking driver that rotates with the inside access control;
a subassembly between the handle crank and the blocking driver; and
the subassembly including a seat operable to push, but not pull, a slider;
wherein when the inside access control and blocking driver are in a blocking position, rotation by a person of the inside handle in one direction rotates the crank, which forces the seat to push the slider and rotate the blocking driver into an unblocking position, thus obviating any need for the person to operate the inside access control in order to exit the access-controlled area;
wherein return of the inside handle to a neutral position separates the seat from the slider, maintaining the inside access control and blocking driver in an unblocking position.

22. The lockset of claim 9, wherein the lockset, when installed in the accessway, further comprises an outside access control vertically offset from the outside handle and the inside access control is vertically offset from the inside handle, wherein:
the outside access control and inside access control are vertically offset from each other;
the inside access control is not hindered by the outside access control to extend and retract the bolt;
the inside access control, when operated to extend the bolt, hinders the outside access control from operating the bolt; and
the lockset provides a function that:
denies entry through the accessway into the access-controlled area by operation of the outside handle alone, even when the inside access control is not in the locking state;
permits entry through the accessway into the access-controlled area when both the inside and outside access controls are not in the locking state; and
denies entry through the accessway into the access-controlled area when the inside access control is in a locking state when only the outside access control is operated to unlock the bolt.

23. The lockset of claim 22, wherein:
the inside access control is a thumbturn; and
the outside access control is a key cylinder.

24. A lockset comprising:
an outside trim or housing with guides;
an outside handle;
an outside handle spindle;
a stop plate riding on the outside handle spindle, the stop plate having a first slot;
an inside access control that, when assembled, comprises:
a hand-operated lock lever;
an inside lock spindle operated by the hand-operated lock lever;
a blocker driver extending radially from and rotating with the inside lock spindle;
a blocker guided for linear movement in or out of the first slot between a blocking position that prevents rotation of the outside handle and a non-blocking position that allows the outside handle to be rotated when the outside handle is otherwise free to rotate; and
a linkage that that pivotally links the blocker driver to the blocker, wherein movement of the linkage by the inside lock spindle causes the blocker to move in or out of the stop plate slot; and
an indicator plate configured to slide vertically within the outside trim or housing via the guides in unison with the movement of the blocker between blocking and non-blocking positions;
wherein the indicator plate provides a visual indication of a status of the lockset.
